(19) United States
(12) Patent Application Publication
(10) Pub. No.: US 2013/0323357 A1
(43) Pub. Date: Dec. 5, 2013

(54) CONTAINERS FOR FERMENTED SOYBEANS (NATTO), FERMENTED SOYBEANS WITHIN SAID CONTAINERS, AND METHOD FOR MANUFACTURING SAME

(71) Applicant: Masaki Ohike, Aichi (JP)

(72) Inventor: Masaki Ohike, Aichi (JP)

(73) Assignees: MIZKAN CO., LTD., Aichi (JP); MIZKAN GROUP CORPORATION, Aichi (JP)

(21) Appl. No.: 14/000,012

(22) PCT Filed: Feb. 10, 2012
(86) PCT No.: PCT/JP2012/053737

§ 371 Date: Aug. 16, 2013

(30) Foreign Application Priority Data
Feb. 17, 2011 (JP) 2011-032670

(51) Int. Cl. B65D 85/72; A23L 1/20

(52) U.S. Cl. CPC B65D 85/72; A23L 1/2008
USPC 426/8; 426/120; 206/524.6

(57) ABSTRACT

A natto (fermented soybeans) container 11 is made of a resin-foam sheet of a structure of which a lid body, having a natto-holding recess, is connected by a hinge part to, and covering the opening of the container body. A seasoning-holding recess is provided adjacent to the inner-lid surface of the lid body. A pre-defined folding line L1 is described on the outer-lid surface of the lid body, along which the lid body folds upward into a valley shape. A splittable groove, provided on the lid body, communicates with the natto seasoning-holding recesses and crosses the pre-defined folding line L1. A sealant material is provided on the outer-lid surface, covering and sealing the seasoning holding recess. Hence, the lid body folds into a valley-shape along the pre-defined folding-line crossing, thus breaking the splittable groove.

### TECHNICAL FIELD

This invention relates to containers for fermented soybeans (natto); to the fermented soybeans within the same containers; and to the method for manufacturing same, by which the fermented soybeans and separately packaged fermented-soybean seasoning are enclosed in the same containers.

### BACKGROUND ART

Natto is now sold in a paper or synthetic-resin container, generally with separately packaged natto seasoning or the like enclosed in the same container, which must first be removed from the natto container before applying it to the natto before eating it. Yet, such a procedure is usually messy, since the seasoning may adhere to the fingers upon opening the separately packaged seasoning, or the seasoning may spill from the package due to too much pressure being applied by the fingers upon opening the package. Also, the seasoning package may become discarded waste, which is unfavorable from an ecological point of view.

Due to this unfavorable procedure in applying the seasoning to the natto, it has been proposed that natto seasoning no longer be packaged separately from the natto. Patent Documents 1 to 3, below, describe natto containers that no longer necessitate the natto seasoning be applied to the natto from an enclosed separate package, thereby at least resolving the problem of soiled fingers.

Patent Document 1 refers to structures of natto containers of which the unbreakable synthetic-resin lids embody a concaved recess for storing natto seasoning, with the seasoning being sealed within the recess by an easily-breakable sealant material; and of which the seasoning is applied to the natto before eating it upon the sealant material being broken by a protruding part that is formed within the recess of the lid body.

Patent Document 2 refers to structures of natto containers of which the unbreakable synthetic-resin lids embody a concaved recess for storing natto seasoning, with the recess being sealed by a sealant material; and of which the seasoning is applied to the natto before eating it upon the sealant material being pulled and removed to open the concaved recess.

Patent Document 3 refers to structures of natto containers of which a concaved recess for storing natto seasoning is formed within the hinged moldable-resin lid of the container, with a breakable groove described on the hinge part, and with a sealant material firmly sealing the concaved recess of the lid body; and of which the seasoning is applied to the natto before eating it upon the hinged lid body being lifted and removed along the breakable groove, thus removing the sealant material and opening the concaved recess.

### PRIOR ARTS

Patent Document 1: JP-A-2002-179174
Patent Document 2: JP-A-2002-37349
Patent Document 3: JP-A-H10-305886

### DISCLOSURE OF THE INVENTION

### Problems to be Solved by the Invention

However, the natto containers as proposed in the above Patent Documents 1 to 3 are problematic, as described below.

For instance, the containers as described in Patent Documents 1 and 2 are structurally very complicated, and since it is necessary to provide a breakable protruding part and a band of sealant, it is unpractical to make such natto containers due to the high cost of raw materials and of manufacturing. Especially, the containers as described in Patent Document 2 generate waste such as the band of sealant or the like after use, and due to the band of sealant normally being soiled with the natto seasoning, one hesitates to lay it directly upon the table after use, thus not only becoming waste but causing an inconvenience, and such waste is unfavorable from an ecological point of view.

The lids of the containers as described in Patent Document 3 must be detached, and the band of sealant must be removed to open the concaved recess. In removing the band of sealant, the fingers are soiled, and the sealant material becomes waste. If there were no sealant material to prevent the natto from adhering to the lid, both the outer and inner surface of the detached lid would become soiled with the seasoning. Furthermore, the detached soiled lid cannot handily be set on the table, thus causing an inconvenience.

This invention was achieved in light of the aforementioned problems to provide an excellent natto container and the natto within, which can easily apply natto seasoning without causing soiling or as much waste upon using it yet can be manufactured at a comparatively low cost. This invention was also achieved to provide a preferable way for manufacturing the natto within a more excellent container, as described above.

### Means of Solving the Problems

Below are means (1) to (12) for solving the problems.

(1) The first aspect of this invention refers to a resin-foam natto (fermented soybeans) container, characterized by comprising a structure of which the container body and the lid body, having a natto-holding recess and covering the opening of the container body, are connected by a hinge part; and of which a protruding seasoning-holding recess is adjacent to the inner-lid surface of the lid body; and of which a pre-defined folding line is described on the inner-lid surface of the lid body, along which the lid body folds into a valley shape; and of which a splittable groove communicates with the seasoning-holding recesses and crosses the pre-defined folding line; and of which a sealant material is provided on the outer-lid surface to cover and seal the opening of the seasoning-holding recess, onto which outer-lid surface the lid body folds into a valley-shape along the pre-defined folding-line crossing, thus splitting the splittable groove on the pre-defined folding-line crossing.

As such, according to the above first aspect of this invention, upon the lid body folding into a valley-shape along the folding line on the outer-lid surface, the splittable groove splits on the pre-defined folding-line crossing, thus letting the seasoning within the seasoning-holding recess seep downward along the splittable groove to the breakage area and eventually spill onto the natto. In this case, though, the lid body, being made of a resin foam, even without a cutting line, will fold into a valley-shape onto the outer-lid surface in a comparatively simple way, thus letting the seasoning held within the seasoning-holding recess to discharge. This invention, needing no splittable protruding part or a band of sealant, makes the structure simple and able to be produced at a comparatively low cost. Of this invention, the natto-holding recess of the natto container is made of a metal molding, originally of a flat sheet of resin foam, making it possible then to form the seasoning-holding recess and the splittable groove. Thus, using a hard plastic is unnecessary, which greatly simplifies the manufacturing of the natto containers and lets them be manufactured at a considerably low cost. Also, the container of this invention is of a structure of which the seasoning can be discharged without breaking or separating the sealant material, thus avoiding generating discarded waste such as the sealant material or the like after use. Also, this structure, by employing a simple procedure, allows for the discharge of the seasoning without the fingers becoming soiled.

The pre-defined folding line of this invention refers to an imaginary folding line and not necessarily an actual line on the specific area of the lid body. However, such a line could actually be provided accordingly. Of this invention, the seasoning-holding recess is provided on the mountain-folding side (opposite the valley-folding side), and each of the pair of the seasoning-holding recesses do not press upon each together. However, resin-foam is strongly elastic and easily expands, so that it is possible whilst being folded to press it with the fingers on the outer surface, thus making it possible to discharge even highly viscous seasoning.

(2) The second aspect of this invention refers to a natto (fermented soybeans) container, according to the first aspect, characterized by a folding groove or perforated folding-line, being described on at least part of the pre-defined folding line of the lid body, that breaks on the outer-lid surface of the lid body.

According to the invention of the second aspect, a folding groove or perforated folding line is pre-formed on at least a part of the pre-defined folding line, so that the lid body will easily and accurately fold into a valley shape along the pre-defined folding line, thus making it possible to split the splittable groove surely on the favorable area to discharge the seasoning surely and easily from the container. Such an actual folding groove or perforated folding line makes it visually easy to recognize the pre-defined folding line during folding.

(3) The third aspect of this invention refers to a natto (fermented soybeans) container, according to the second or third means, characterized by the bottom part of the seasoning-holding recess slanting toward the splittable groove.

Thus, according to the invention of the third aspect, the bottom part of the natto seasoning-holding recess, slanting toward the splittable groove, smoothly makes it possible for the seasoning to flow to the splittable part of the seasoning-holding recess, to discharge the seasoning surely and easily from the container.

(4) The fourth means of this invention refers to a natto (fermented soybeans) container, according to one of means 1 to 3 above, that is characterized by a separation procedure existing in the vicinity of the hinge part that lets the lid body be detached from the container body.

As such, according to the invention of the fourth aspect, the separation-procedure part lets the lid body be separated from the container body, which gives the user of the natto container the option to separate or not separate the lid body upon pouring the seasoning.

(5) The fifth aspect of this invention refers to a natto container, according to the fourth aspect, that is characterized by the pre-defined folding line being described in parallel with the hinge part.

According to the invention of the fifth aspect, the user of the natto container can easily fold the lid body along the pre-defined folding line simply by separating an adhered section of the pre-defined folding line between the lid body and the container body without completely separating them, thus making it easier to apply the seasoning to the natto.

(6) The sixth aspect of this invention refers to a natto container, according to any one of the above first to fifth aspects, that is characterized by an encompassing groove being described on the lid body that does not cross the pre-defined folding line yet encompasses the seasoning-holding recess and the splittable groove.

According to the invention of the sixth aspect, providing an encompassing groove to encompass the seasoning-holding recess and the splittable groove reinforces the entire lid body, thus preventing it from warping and preventing the sealant material from potentially riding up. However, since the encompassing groove is not provided on the area of the pre-defined folding line, the vicinity of the pre-defined folding line of the lid is not reinforced, thus making it possible for the lid to be folded accurately and simply into a valley shape along the pre-defined folding line and preventing it from folding at a part other than on the pre-defined folding line.

(7) The seventh aspect of this invention refers to the natto and natto seasoning that are held respectively in the natto-holding recess and in the seasoning-holding recess of the container body, according to any one of the above first to sixth aspects.

According to the invention of the seventh aspect, having the lid body fold outwardly into a valley shape makes it possible for the natto seasoning to flow easily from the natto-seasoning holding recess and unnecessary to provide a splittable protruding part or sealant material, thereby making a simple structure that can be produced at a comparatively low cost. The natto-holding recess of the natto container of this invention is made of a metal molding, originally of a fiat sheet of resin foam, making it possible to form the natto-seasoning holding recess and the splittable groove at the same time and unnecessary to use a hard plastic, thus simplifying greatly the process of manufacturing such a natto container, thus letting it be manufactured at a considerably low cost. Also, the natto container of this invention has a structure of which the natto seasoning can be discharged without breaking or separating the sealant material, thus avoiding generating discarded waste such as the band of sealant or the like after use. Therefore, the natto container can be used to discharge the seasoning without the fingers being soiled or without any complicated procedures. Thus, whilst convenience is highly improved, the natto packed in the container is provided at a comparatively low price.

(8) The eighth aspect of this invention refers to the method for making the natto packed in the container body, according to any one of the above first to sixth aspects, that is characterized in comprising a natto-seasoning filling process for filling the natto seasoning into the natto-seasoning holding recess of the lid body; a sealing process, using a sealant material, for sealing the natto-seasoning holding recess filled with the natto seasoning; a steamed-soybeans filling process for filling the natto-holding recess of the container body with steamed soybeans; a lid-body closing process for closing the lid body filled with the natto seasoning and sealed by a sealant material to cover the natto-holding recess filled with the fermented soybeans; and a fermenting process for fermenting in a fermenting room Bacillus subtilis natto in the container body filled with both the steamed soybeans and the natto seasoning.

According to the invention of the eighth aspect, being orderly, of filling the natto-seasoning holding recess with natto seasoning, sealing the recess by a sealant material, filling the recess with steamed soybeans and then closing the lid body, there are some advantages, as below. For example, if the steamed soybeans are packed in the container body and the natto-seasoning holding recess is filled with natto seasoning and then sealed by a sealant material, the container body is likely to be distorted, in which case it would be necessary to take a long time to complete the sealing process well, or to provide the sealing position as close to the edge of the lid body as possible. According to this invention, though, it is possible to hold firmly and seal the lid body, as required, thus making it possible to prevent the container body from being distorted. That is, without having any special procedure designed for the sealing process, the lid body can surely be sealed. Also, in the case where the steamed soybeans are firstly packed, and then the natto seasoning is packed and sealed, if an erroneous procedure such as liquid-leakage or imperfect-sealing or the like happens during the natto-seasoning filling process, the steamed soybeans that are already filled in the recess become spoiled. However, this invention will eliminate such waste. In other words, whenever such an erroneous procedure is likely to happen in the natto-seasoning-filling and sealing process, this manufacturing method is worth using. Furthermore, of this invention, in the comparatively early stage of the sealing process, the natto seasoning is packed and then sealed by the sealant material, thus reducing the chance of foreign-matter or bacterial contamination within the natto-seasoning holding recess, which is hygienically preferable.

(9) The ninth aspect of this invention refers to the method for making the natto packed in the container body, according to any one of the above first to sixth aspects, that is characterized in comprising a steamed-soybeans-filling process for filling the natto-holding recess with steamed soybeans; a lid-closing process for closing the lid body of the natto container, thus sealing the natto-holding recess filled with the steamed soybeans; a natto-seasoning filling process for filling the natto-seasoning holding recess of the lid body with natto seasoning; a sealing process, using a sealant material, for sealing the natto-seasoning holding recess filled with the natto seasoning; and a fermenting process for fermenting in a fermenting room Bacillus subtilis natto in the container body filled with both the steamed soybeans and the natto seasoning.

According to the invention of the ninth aspect, being orderly, of filling the natto-holding recess and natto-seasoning holding recess with the steamed soybeans and with the natto seasoning, respectively, and in sealing the recesses by the sealant material and by closing the lid body, there are some advantages, as described below. As the series of procedures is conducted, even though there is some inconvenience in the sealing process, it is unnecessary to invert the natto container, although doing so is preferable in simplifying the manufacturing assembly line. Also, if erroneous procedures should happen, such as contamination of the container body due to leakage of the steamed soybeans, or if a container body should break or the like should happen during the steamed-soybeans filling process or the lid-closing process, the seasoning that has already been filled in the natto-seasoning holding recess and the sealant material that has already been used become spoiled. However, this invention eliminates such waste. In other words, whenever such erroneous procedures are likely to happen in the steamed-soybeans-filling process, this manufacturing method is worth using.

(10) The tenth aspect of this invention refers to the method for making the natto that is packed in the container body, according to any one of the above first to sixth aspects, that is characterized in comprising a steamed-soybeans filling process for filling the natto-holding recess of the container body with the steamed soybeans; a lid-closing process for closing the lid body of the container body, thus sealing the natto-holding recess filled with the steamed soybeans; a fermenting process for fermenting in a fermenting room Bacillus subtilis natto in the container body filled with the steamed soybeans; a seasoning-filling process for filling the seasoning-holding recess of the lid body with natto seasoning; and a sealing process, using a sealant material, for sealing the seasoning-holding recess filled with the natto seasoning.

According to the invention of the tenth aspect, being orderly, of filling the natto-holding recess with steamed soybeans; in closing the lid; in fermenting Bacillus subtilis natto; in filling the natto-holding recess with seasoning; in sealing the natto-holding recess and natto-seasoning holding recess by using a sealant material, such means can be used problem-free in a manufacturing facility whereat a sustainable hygienic environment is provided. Also, if imperfect fermentation of the natto or the like should happen in the seasoning-packing process, then the fermentation that has already been done, the natto seasoning that has already been packed, and the sealant material that has already been used are spoiled. However, if the natto seasoning is packed and sealed after the fermentation of Bacillus subtilis natto, then such waste can be prevented. In other words, whenever such imperfect fermentation is likely to happen, this manufacturing method is worth using.

### Effects of the Invention

Therefore, the invention of the above first to seventh aspects, is aimed in providing a natto container and natto packed in the container that can easily provide natto seasoning without causing soiling and waste upon using it, yet can be manufactured at a comparatively low cost. Also, according to the invention of the above eighth to tenth aspects, a preferable method for manufacturing the natto packed in the excellent container is provided.

### BRIEF DESCRIPTION OF THE DRAWINGS

FIG. 1 is the top-flat view of the natto container, opened, without the sealant cover attached to the lid.

FIG. 2 is the top-fiat view of the natto container, closed, with the sealant cover attached to the lid.

FIG. 3 is the front view of the natto container, as shown in FIG. 2

FIG. 4 is the cross-sectional A-A Line side view of the natto container, as shown in FIG. 2.

FIG. 5 is the cross-sectional B-B Line side view of the natto container, as shown in FIG. 2.

FIG. 6 is a cross-sectional view of the natto container being opened.

FIG. 7 is a flat view showing another embodiment of the natto container before the lid is closed.

### MODELS FOR CARRYING OUT THE INVENTION

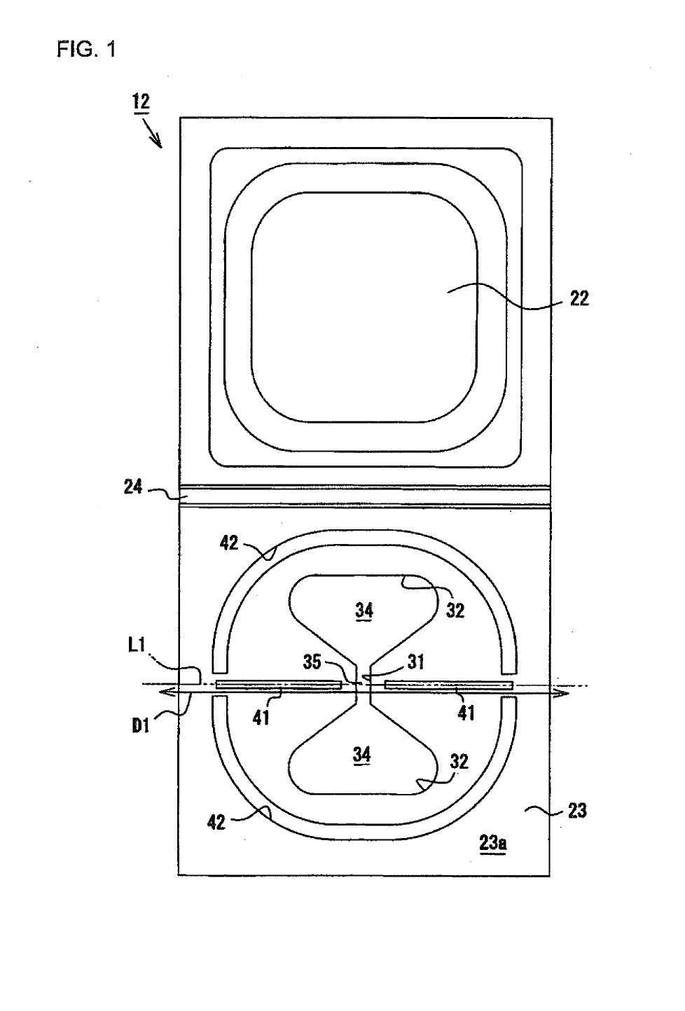

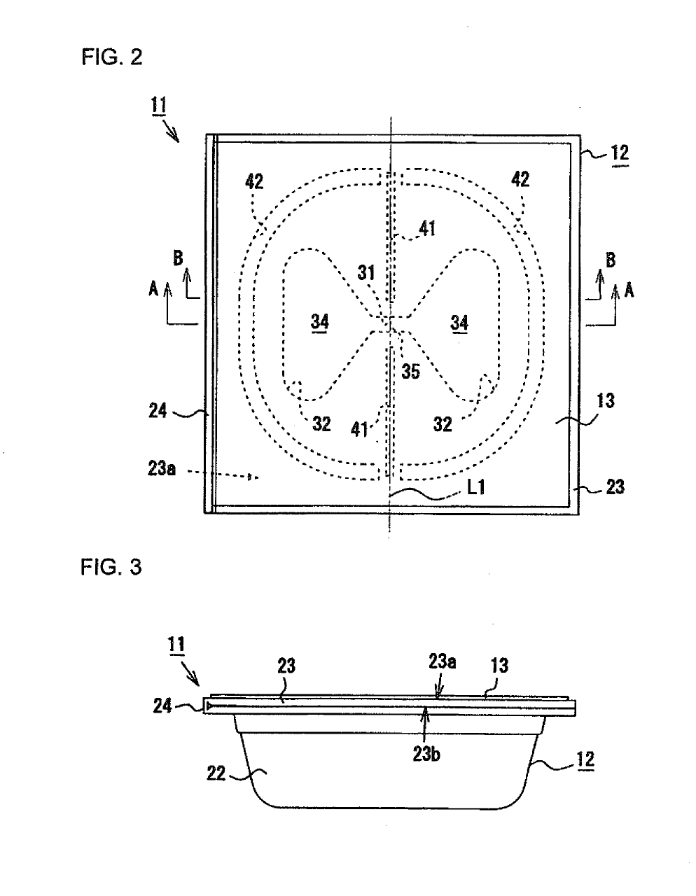

In reference to FIGS. 1 to 6, the preferred embodiments of this invention are described hereinafter. FIG. 1 is the top-flat view of the natto container 11, opened, without the sealant cover having been attached to the lid. FIG. 2 is the top-flat view of the natto container 11, closed, with the sealant cover having been attached to the lid. FIG. 3 is the front view of the natto container 11, as shown in FIG. 2.

The natto container 11, as an embodiment of this invention, is a container having a structure of which the natto 2 and the natto seasoning 3 are separately packed inside, and of which the natto seasoning 3 is accordingly applied to the natto 2. This natto container 11 consists of a molded unit 12 made of a resin-foam sheet and of the sealant material 13, which molded unit 12 comprises the container body 22, the lid body 23, and the hinge part 24. The container body 22 is planar-rectangular and comprises the natto-holding recess 25 and the opening 26 at the upper section part of the container body 22. The natto 2 is packed within the natto-holding recess 25. The lid body 23, also planar-rectangular, covers the opening 26 of the container body 22 to which the lid body 23 is connected by the hinge part 24.

As shown in FIG. 1 and in the other Figs., the thickness of the molded unit 12a of the resin-foam sheet of the natto container 11 is preferably three millimeters or less. Of this invention, the thickness of the molded unit 12a is approximately 1.5 millimeters. The material used in making the resin-foam sheet includes foamed-polystyrene resin, foamed-polyethylene resin, and foamed-polyurethane resin or the like. The shorter sides (i.e. those in the horizontal direction of the molded unit 12, as shown in FIG. 2, are in the take-up direction of the whole resin-foam sheet, rather than in the longitudinal direction-of the longer sides of the whole resin-foam sheet. The molded unit 12 of the resin-foam sheet comprises many air bubbles inside, which are closed pores and shaped as a rotating spheroid and are aligned in a long axis extending in the direction called the “Air-bubble orientation direction D1.” Therefore, it is understood that the air bubbles are oriented in the same direction as the shorter sides of the molded unit 12 of the resin-foam sheet.

Of the embodiment of this invention, for the lid body 23 to fold into a valley shape onto the outer-lid surface 23a, a pre-defined folding line L1 is described through the central area of the lid body 23 of the molded unit 12 of the resin-foam sheet and in parallel with the air-bubble orientation direction D1. (See FIG. 1) It is preferable to set the pre-defined folding line L1 at angle θ of ±45 degrees to the air-bubble orientation direction D1 of the molded unit 12 of the resin-foam sheet, so that the splittable area can easily and sharply be broken. Of this invention, angle θ is set at zero (θ=0 degrees). In other words, the pre-defined folding line L1 and the air-bubble orientation direction D1 are aligned in parallel.

As shown in FIGS. 1 to 7, the lid body 23, as the embodiment of this invention, comprises a pair of seasoning-holding recesses 32 and a cross-sectional V-shaped splittable groove 31, which recesses 32 are to split on the outer-lid surface 23a. The splittable groove 31 and the pair of seasoning-holding recesses 32 are connected on the lid body 23, which pair of recesses 32 and the splittable groove 31 are formed in the making of the molded unit 12 made by metal-molding a flat resin-foam sheet to make the specific sections that protrude into the outer edge of the sheet. The splittable groove 31 is described on the central part of the lid body 23 of the molded unit 12 and crosses the pre-defined folding line. Therefore, the splittable groove 31 extends in parallel with the air-bubble orientation direction D1, with each of the seasoning-holding recesses 32 being provided on either side of the splittable groove 31. According to the embodiment of this invention, each of the pair of recesses 32 is of the same size and shape, though not necessarily. The width of the seasoning-holding recesses 32, as seen in the planar view of the molded unit 12 of the resin-foam sheet, is seen gradually narrowering toward the splittable groove 31.

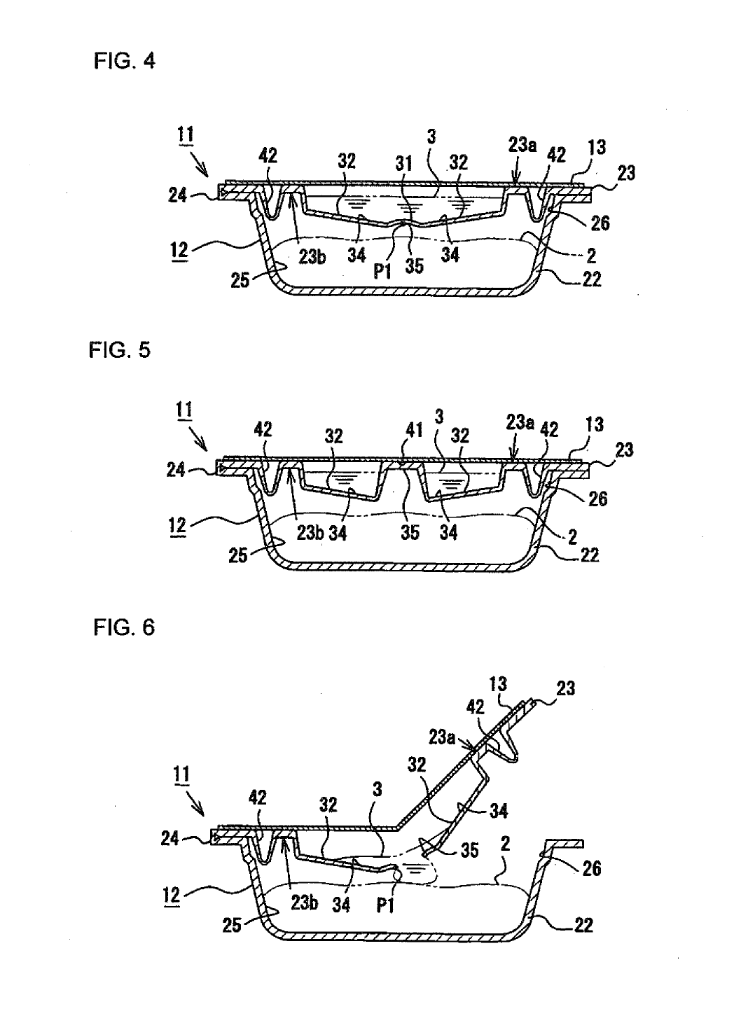

As shown in FIGS. 4 and 5, the bottom part 34 of the seasoning-holding recess 32 slants at 5 to 30 degrees toward the splittable groove 31, which slanted bottom surface can be either of the entire bottom part 34 or of a certain part of the bottom part 34. The point where the seasoning-holding recess 32 is connected to the splittable groove 31 is the deepest part of the recess 32. As shown in FIG. 4, the deepest part of the seasoning-holding recess 32 is not specifically limited, but it is preferable to set the depth at 5 millimeters or more. (Of this invention, the maximum depth is set at approximately 8 millimeters.) The shallowest part of the splittable groove 31 is not specifically limited, but it is preferable to set the depth at 5 millimeters or more. (Of this invention, the minimum depth is set at approximately 7 millimeters.) Also, the length of the splittable groove 31 is specifically limited, but it is preferable to set the length at 5 millimeters. (Of this invention, the length is set at approximately 12 millimeters, so that the splittable groove 31 can more easily split to prevent any resin dust from surely emitting from the resin-foam sheet.)

As shown in FIG. 1 of the planar view of the molded unit 12 of the resin-foam sheet, the part on which the pre-defined folding line L1 crosses the splittable groove 31 (hereinafter referred to as the pre-defined folding-line crossing 35) is the part most likely to receive stress whilst the lid body 23 is folding into a valley shape onto the outer-lid surface 23a of the lid body 23. For example, regarding the pre-defined folding-line crossing 35 of the splittable groove 31, the air-bubble orientation direction D1 can be reduced or lost. As such, even if the pre-defined folding line L1 is not at angle θ within ±45 degrees against the air-bubble orientation direction D1 of the molded unit 12 of the resin-foam sheet, the splittable area will easily and sharply split. The specific orientation-reduction-and-loss treatment is as follows. Prepare a resin-foam sheet comprising the seasoning-holding recess 32 and the splittable groove 31. Apply heat to the pre-defined folding-fine crossing 35, (specifically to the bottom-central section of the splittable groove 31, which is most likely to receive the stress). As for the tool to be used in doing this heating treatment, use a hot roller, and with it make contact with the bottom-central section of the splittable groove 31, whilst the lid body 23 is being transferred in the making process.

As shown in FIGS. 1, 2, and 4-6, two folding grooves 41 that are to split on the outer-lid surface 23a are described on the pre-defined folding line L1 of the lid body 23 and face each other across the splittable groove 31. The length of each folding groove 41 is approximately one-third the length of the short sides of the molded unit 12 made of the resin-foam sheet. In other words, the folding groove 41 is not provided all the way across the width of the molded unit 12 of the resin-foam sheet but only partially. Yet, it is acceptable for the folding groove 41 to be described across the whole width. To prevent leakage of the seasoning 3, however, the folding groove 41 preferably is not connected to the splittable groove 31. The depth of the folding groove 41, which can be set at 3 millimeters or less, is not necessarily greater than that of the seasoning-holding recess 32 and of the splittable groove 31. (This invention sets the depth of the folding groove 41 at about 1 millimeter.)

As shown in FIGS. 1, 2, and 4-6, an encompassing groove 42 is described on the lid body 23, which is to be broken on the outer-lid surface 23a and which encompasses almost all of the seasoning-holding recess 32 and the splittable groove 31, thus entirely reinforcing the lid body 23. However, for the lid body 23 to be folded conveniently into a valley shape, the encompassing groove 42 does not cross the pre-defined folding line L1 (nor the folding groove 41). The depth of the encompassing groove 42, set at about 7 millimeters or less, is not necessarily greater than that of the seasoning-holding recess 32 and of the splittable groove 31 (This invention sets the depth if the encompassing groove 42 at about 5 millimeters.)

As shown in FIGS. 2 to 6, a resin film, used as the sealant material 13, being flexible and of liquid impermeability, is thermally welded onto the outer-lid surface 23a of the lid body 23. The sealant material 13, being made of a resin film, is of a simple and nearly flat structure, without any special embossing treatment. Possible resins that can be used in making the sealant material 13, for example, are general-purpose resins such as polyethylene, polypropylene or the like. The sealant material 13 is thermally welded to cover the entire area of the outer-lid surface 23a, thereby sealing the seasoning 3 within the seasoning-holding recess 32. It is optional to use either a transparent or an opaque type of sealant material 13. If the former is used, it is possible to check the condition or the like visually of the seasoning 3, or an inspection machine can be used for check. If the latter is used, it can prevent the seasoning 3 from deteriorating or the like due to exposure to light. Hence, the seasoning 3 for the natto is of the liquid type.

Next, the way of opening the natto container 11, as an embodiment of this invention, is described in reference to FIG. 6. Firstly, prepare the natto container 11 by packing it with the natto 2 and with the natto seasoning 3. Of this natto container 11, a flange part of the container body 22 and of the lid body 23 are welded together. When opening the container 11, detach about half of the welded part that lays between the lid body 23 and the container body 22. Then, fold the lid body 23 into a valley shape, along the pre-defined folding line L1, onto the outer-lid surface 23a, at which time the pre-defined folding-line crossing 35 of the splittable groove 31, described on the lid body 23, especially at the bottom-central region P1, is horizontally pulled to receive stress intensively, thus breaking sharply at the bottom-central region P1 and opening prior to the other part of the splittable groove 31, resulting in the seasoning 3 discharging from the lid body 23 onto the natto 2 within the natto-holding recess 25.

Hereinafter, as an embodiment of this invention, the methods for manufacturing the natto within the container are described in reference to the several examples.

(Method 1)

The first method of manufacturing is as follows. Firstly, prepare the natto container 11, as shown in FIG. 1, placing it with the outer-lid surface 23a up. Using a filling machine (not shown in the drawings), a certain amount of the natto seasoning 3 is filled into the pair of the seasoning-holding recesses 32 (the seasoning-filling process). Secondly, the sealant material 13 is thermally welded to seal the opening of the seasoning-holding recess 32 filled with the natto seasoning 3, to prevent the seasoning-holding recess 32 from leaking (the sealing process). Thirdly, after the sealing process, invert the natto container 11, thus placing it with the opening 26 of the natto-holding recess 25 of the container body 22 up. Then, using a different filling machine, not shown in the drawings, a certain amount of steamed soybeans 2 are filled into the natto-holding recess 25 of the container 22 (the steamed-soybeans filling process). Fourthly, fold the natto container 11, filled with the natto seasoning 3 and sealed with the sealant material 13, at the hinge part 24 to close the lid body 23 and natto-holding recess 25 filled with the steamed soybeans 2 (the lid-closing process). Finally, store the natto container 11 filled with the steamed soybeans 2 and with the natto seasoning 3 in a fermenting room for a certain period of time to ferment Bacillus subtilis natto (the fermenting process). As such, manufacturing the preferable natto within the container is completed.

According to the above first method of manufacturing, being orderly in filling the natto-seasoning holding recess 32 with the seasoning 3; in sealing the recess 32 by the sealant material 13; and in filling the recess 25 with the steamed soybeans and then closing the lid body 23, there are some advantages, as described below. For example, if the steamed soybeans are packed in the container body 22, and then the recess 32 is filled with the seasoning 3 and sealed by the sealant material 13, the container body 22 is likely to be distorted, in which case it would be necessary to take a long time in sealing to realize a good condition or to provide the sealing position as close to the edge of the lid body 23 as possible. According to this invention, though, it is possible to firmly hold and seal the lid body 23, as required, thus making it possible to prevent the container body 22 from being distorted. That is, without any special procedure designed in the sealing process, the lid body 23 can surely be sealed. Also, in the case where the steamed soybeans 2 are firstly packed and then the seasoning 3 is packed and sealed, if an erroneous procedure such as a leakage of liquid or an imperfect sealing or the like happens in the seasoning-filling process, the steamed soybeans that are already filled in the recess become spoiled. However, this invention will eliminate such waste. In other words, whenever such erroneous procedures are likely to happen in the seasoning-filling and sealing process, this manufacturing method is worth using. Furthermore of this invention, in the comparatively early stage of the seasoning-filling and sealing process, the seasoning 3 is packed and sealed by the sealant material 13, thus reducing the chance of any foreign matter attaching to the seasoning 3 or of the seasoning 3 being contaminated with bacteria within the seasoning-holding recess 32, which is hygienically preferable.

(Method 2)

The second method for manufacturing the natto is as follows. Firstly, prepare the natto container 11, as shown in FIG. 1, by placing it with the outer-lid surface 23a down and with the opening 26 of the natto-holding recess 25 of the container 22 up. Then, using a filling machine (not shown in the drawings), a certain amount of the steamed soybeans 2 are filled into the natto-holding recess 25 of the container body 22 of the container 11 (the steamed soybeans-filling process). Secondly, fold the natto container 11, filled with the steamed soybeans 2, at the hinge part 24 to close the lid body 23 and natto-holding recess 25 of the natto container 11 (the lid-closing process). Thirdly, using a different filling machine (not shown in the drawings), a certain amount of the natto seasoning 3 is filled into the natto-seasoning holding recess 32 of the lid body 23 (the natto seasoning-filling process). Fourthly, the sealant material 13 is thermally welded to seal the opening of the natto-seasoning holding recess 32 filled with the natto seasoning 3, to prevent the natto-seasoning holding recess 32 from leaking (the sealing process). Finally, store the natto container 11, filled with the steamed soybeans 2 and with the natto seasoning 3, in a fermenting room for a certain period of time to ferment Bacillus subtilis natto (the fermenting process). As such, manufacturing the preferable natto within the container is completed.

According to the above second method of manufacturing, being orderly in filling the natto-holding recess 25 and the natto-seasoning holding recess 32 with the steamed soybeans 2 and with the natto seasoning 3, respectively, and in sealing the recesses by the sealant material 13 and by closing the lid body 23, there are some advantages, as described below. As the series of procedures are conducted, even though there is some inconvenience in the sealing process, it is unnecessary to invert the natto container 11, which is preferable in simplifying the manufacturing line. Also, if erroneous procedures such as contamination of the container due to leakage of the steamed soybeans 2 or due to container-breakage or the like should occur in the steamed-soybeans-filling process or in the lid-closing process, the seasoning 3 that is already filled in the recess and the sealant material 13 that has already been used become spoiled. However, this invention will eliminate such waste. In other words, when such erroneous procedures are likely to occur in the steamed-soybeans-filling process, this manufacturing method is worth using.

(Method 3)

The third method of manufacturing the natto is as follows. Firstly, prepare the natto container 11, as shown in FIG. 1, placing it with the outer-lid surface 23a down and the opening 26 to the natto-holding recess 25 of the container body 22 up. Then, using a filling machine (not shown in the drawings), a certain amount of the steamed soybeans 2 are filled into the natto-holding recess 25 of the container body 22 of the container 11 (the steamed-soybeans filling process). Secondly, fold the natto container 11, filled with the steamed soybeans 2, at the hinge part 24 to close the natto-holding recess 25 with the lid body 23 (the lid-closing process). Thirdly, store the natto container 11, filled with the steamed soybeans 2 and with the natto seasoning 3, in a fermenting room for a certain period of time to ferment Bacillus subtilis natto (the fermenting process). Finally, the sealant material 13 is thermally welded to seal the opening of the seasoning-holding recess 32 filled with the natto seasoning 3, to prevent the seasoning-holding recess 32 from leaking (the sealing process). As such, manufacturing the preferable natto 2 within the container body 22 is completed.

According to the above third method of manufacturing, being orderly in filling the natto-holding recess 25 with the steamed soybeans 2; in closing the lid body 23; in fermenting Bacillus subtilis natto; in filling the natto-seasoning recess 32 with the natto seasoning 3; and then in sealing the natto-holding recess 25 and the natto-seasoning recess 32 by using the sealant material 3, such means can be used problem-free in any manufacturing facility that provides a sustainable hygienic environment. Also, if imperfect fermentation of the natto 2 or the like should occur in the process in which the seasoning 3 is packed or in which the fermentation is conducted, then the natto seasoning 3 that is already packed, and the sealant material 13 that has already been used, become spoiled. However, if the natto seasoning 3 is packed and sealed after the fermentation of Bacillus subtilis natto, then such waste can be prevented. In other words, when such imperfect fermentation is likely to occur, this manufacturing method is worth using.

Therefore, the embodiment of this invention allows the following effects.

(1)

According to the natto container 11 as an embodiment of this invention, upon the lid body 23 folding into a valley-shape along the folding line LI on the outer-lid surface 23a, the pre-defined folding-line crossing 35 of the splittable groove 31 splits, thus letting the natto seasoning 3 within the seasoning-holding recess 32 to seep downward along the splittable groove 31 to spill onto the natto 2. In this case, though, the lid body 23, being made of resin-foam, even without a cutting line, will fold into a valley shape onto the outer-lid surface 23 in a comparatively simple way, thus letting the natto seasoning 3 held within the seasoning-holding recess 32 to discharge. This natto container 11, rather than a conventional container, needs no splittable protruding part or band of sealant, thus making the structure simple and able to be produced at a comparatively low cost. According to the natto container 11 of this invention, the natto-holding recess 25 or the like is originally made of a flat sheet of resin foam by metallic molding, which process can also be used in forming the seasoning-holding recess 32 and the splittable groove 31. Thus, it is unnecessary to use a hard plastic, which greatly simplifies the manufacturing of the natto container 11 and lets it be manufactured at a considerably low cost. In addition, the natto container 11 of this invention is of a structure of which the natto seasoning 3 can be discharged without breaking or separating the sealant material 13, thus avoiding generating discarded waste such as the sealant material 13 or the like after use, and this structure, by employing a simple procedure, allows for the discharge of the natto seasoning 3 without the fingers becoming soiled.

(2)

According to the natto container 11, as an embodiment of this invention, a folding groove 41 that is to break on the outer-lid surface 23a, is pre-formed on at least a part of the pre-defined folding line L1 of the lid body 23, so that the lid body 23 can easily and accurately fold into a valley shape along the pre-defined folding line L1, thus making it possible to split the splittable groove 41, surely, on the favorable area to discharge the seasoning 3 surely and easily from the natto-seasoning holding recess 32. Such an actual folding groove 41 makes it easy to recognize visually the pre-defined folding line during folding.

(3)

According to the natto container 11 of this invention, the bottom part 34 of the seasoning-holding recess 32 slants toward the splittable groove 31. Thus, the natto seasoning 3 is smoothly guided into the broken portion of the seasoning-holding recess 32, making it possible to discharge the seasoning 3 from the natto-seasoning holding recess 32 more simply and surely. Especially this container body 22, as disclosed in this invention, by using the slant 34, lets the natto seasoning 3 discharge without having to detach the lid body 23, thus making it easier to discharge the natto seasoning 3, and by the natto-seasoning holding recess 32 being near the hinge part 24, the natto seasoning 3 discharges completely.

(4)

According to the natto container 11, as the embodiment of this invention, the pre-defined folding line L1 is described in parallel with the hinge part 24. Thus, the user (of the container 11) can easily fold the lid body 23, the adhered section of the lid body 23, along the pre-defined folding line L1 simply by lifting the lid body 23 upward (from off the top surface of the container body 22), without having to completely detach the (lid body 23 from the container body 22), thus making it easier to apply the natto seasoning 3 to the natto.

(5)

According to the natto container 11, as the embodiment of this invention, an encompassing groove 42 is described on the lid body 23, which does not cross the pre-defined folding line L1 yet encompasses both the seasoning-holding recess 32 and the splittable groove 31. The encompassing groove 42 reinforces the entire lid body 23, thus preventing it from warping, thus preventing the sealant material 13 from potentially riding up. However, because the encompassing groove 42 does not cross the pre-defined folding line L1, the vicinity of the pre-defined folding line L1, of the lid body 23, is not reinforced, thus letting the lid body 23 to fold accurately and simply into a valley shape along the pre-defined folding line L1 and preventing the lid body 23 from folding at a part other than on the pre-defined folding line Li. Furthermore, the encompassing groove 42 expands convexly toward the inner-lid surface 23b of the lid body 23, which expansion is advantageous, as described below. Whilst applying or after applying the natto seasoning 3, even if it should seep from the splittable groove 31 down to the inner-lid surface 23b of the lid body 23, it is prevented from further seeping downward by the convex-encompassing groove 42 on the inner-lid surface 23b, thus preventing the seasoning 3 from seeping to the edge of the lid body 23, thus preventing the fingers from being soiled or the table from being soiled. For the sake of convenience, the natto 2 within the container body 22 of this invention needs no film to prevent the natto 2 from admitting an odor, for such an admission of odor is eliminated by the use of the aforementioned convex-encompassing groove 42. Also, the natto 2, within the container body 22, though not being covered by such a film, is still not at risk of being exposed to resin dust that would enter the container body 22 from the clearance between it and the lid body 23 if such a film were used, is still being protected from resin-dust contamination by the convex-encompassing groove 42, thus maintaining hygiene.

(6) According to the natto container 11, as an embodiment of this invention, the pre-defined folding line L1 on which the lid body 23 folds into a valley shape onto the side of the outer-lid surface 23a, is set at angle θ at zero degrees to the air-bubble orientation direction D1 of the molded unit 12 that is made of the resin-foam sheet, thus minimizing folding strength to fold the molded unit 12, thus making it possible for the lid body 23 to fold easily into a valley shape onto the outer-lid surface 23a with minimum force without needing a cutting line, thus sharply opening the splittable part. Therefore, the natto seasoning 3 within the natto-seasoning holding recess 32 can easily and surely be discharged from the recess natto-seasoning holding recess 32.

(7)

According to the natto container 11, as an embodiment of this invention, the sealant material 13 is nearly a flat sheet of resin film of a very simple structure without any cutting portion and projection, thus minimizing processing cost. Since it is unnecessary that the sealant material 13 break upon folding, a thin resin film can be used, thus minimizing material cost. By thermally welding the resin film onto the outer-lid surface 23a of the lid body 23, the natto seasoning 3 is prevented from leaking, thus surely holding it within the recess.

(8)

According to the natto 2 within the container 11 as an embodiment of this invention, in closing the container body 22 with the lid body 23, the seasoning-holding recess 32 and the splittable groove 31 are entirely enclosed within the natto-holding recess 25, thus covering and protecting the natto 2, thus preventing the seasoning-holding recess 32 and the splittable groove 31 from being damaged or distorted. Also, the splittable groove 31 faces downward toward the sides of the natto-holding recess 25, so that the seasoning 3 can be discharged by folding naturally, thus making it possible to apply the seasoning 3 conveniently to the natto 2.

The embodiment can also be modified, as follows.

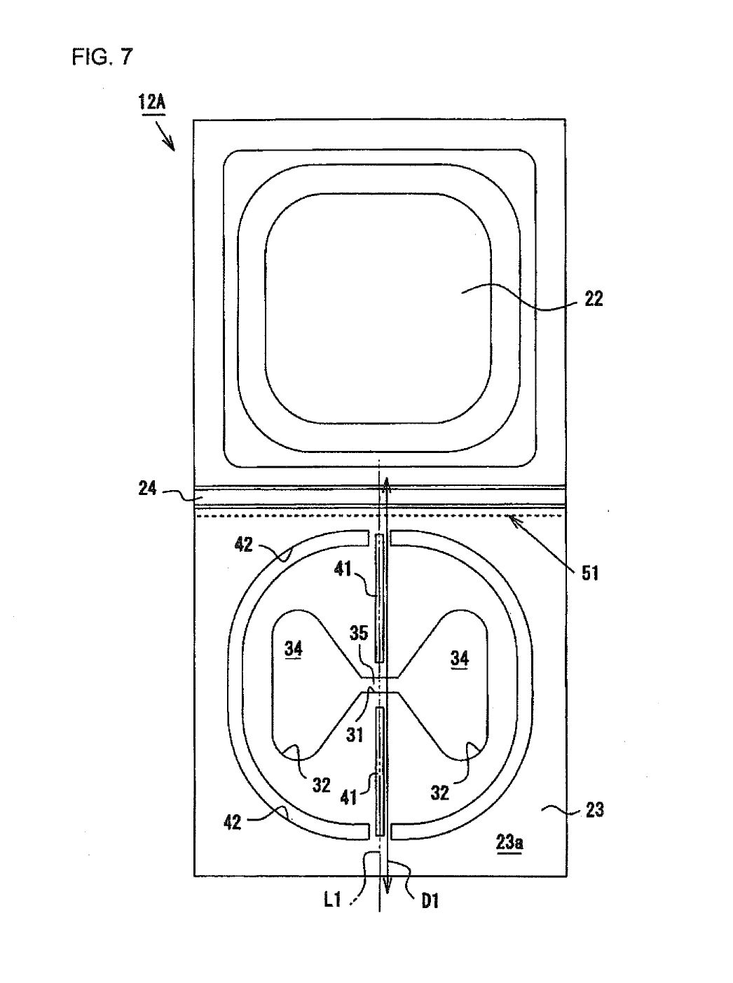

According to the above first embodiment, the separation-procedure part 51, for separating the lid body 23 from the container body 22, is not specifically formed. However, for example, as shown in FIG. 7, the molding unit 12A of a resin-foam sheet, as a different embodiment, can also comprise the separation-procedure part 51 that is formed near the hinge part 24. The separation-procedure part 51 is preferably a perforated line, e.g. one or two perforated lines are formed along the hinge part 24. As such, the lid body 23 can easily be separated from the container body 22. The separation-procedure part 51 gives the user of the natto container 11 the option whether to apply the natto seasoning 3 to the natto after separating or not separating the lid body 23 from the container body 22.

According to the above first embodiment, the pre-defined folding line L1 is described in parallel with the hinge part 24, yet it is not limited to being described in the same direction as the hinge part 24. Also, as shown in FIG. 7, the molded unit 12A, made of a resin-foam sheet and as different embodiment, can optionally comprise the pre-defined folding line L1 being described orthogonally to the direction in which the hinge part 24 extends.

According to the above first embodiment, two seasoning-holding recesses 32 are provided in the lid body 23. However, the number of seasoning-holding recesses 32 is not limited to two, but may be one, three or more.

According to the above first embodiment, only one pre-defined folding line L1 is described, but there may be two or more, in which case those pre-defined folding lines can either be in parallel or not.

According to the above first embodiment, resin film is used as the sealant material 13. However, other types of material can be used. In other words, if the material is of a certain level of thinness, flexibility, and liquid impermeability, the material need not necessarily be a resin but can include, for example, oil impregnated paper, film-coated paper, metal-laminated film, or metal foil or the like.

Based on the above embodiments, the technical ideas to be understood are hereinafter described.
(1) Of either one of the above first to tenth aspects, the pre-defined folding line is set at an angle of ±30 degrees or less (preferably at ±20 degrees or less, ideally at ±10 degrees or less).
(2) Of either one of the above first to tenth aspects, the thickness of the resin-foam sheet is 3 millimeters or less; the minimum depth of the splittable groove is 3 millimeters or less; the length of the splittable groove is 5 millimeters or less.
(3) Of either one of the above first to tenth aspects, the depth of the point where the splittable groove connects to the seasoning-holding recess is greater than that where the pre-defined folding line crosses the splittable groove.
(4) Of either one of the above first to tenth aspects, the seasoning-holding recess is plural.
(5) Of either one of the above first to tenth aspects, the seasoning-holding recess is divided in two and faces each other across the splittable groove.
2. Fermented soybeans (natto)
3. Natto seasoning
11. Natto container
12. 12A. Molded unit
13. Sealant material
22. Container body
23. Lid body
23a. Outer-lid surface
23b. Inner-lid surface
24. Hinge part
25. Natto-holding recess
26. Opening
31. Splittable groove
32. Natto-seasoning holding recess
34. Bottom of natto-seasoning holding recess
35. Pre-defined folding-line crossing
41. Folding groove
42. Encompassing groove
51. Separation-procedure part
L1. Pre-defined folding line

1. A resin-foam natto (fermented soybeans) container, characterized by comprising a structure of which the container body and the lid body, having a natto-holding recess and covering the opening of the container body, are connected by a hinge part; and of which a protruding seasoning-holding recess is adjacent to the inner-lid surface of the lid body; and of which a pre-defined folding line is described on the inner-lid surface of the lid body, along which the lid body folds into a valley shape; and of which a splittable groove communicates with the seasoning-holding recesses and crosses the pre-defined folding line; and of which a sealant material is provided on the outer-lid surface to cover and seal the opening of the seasoning-holding recess, onto which outer-lid surface the lid body folds into a valley-shape along the pre-defined folding-line crossing, thus splitting the splittable groove on the pre-defined folding-line crossing.

2. A natto (fermented soybeans) container, according to claim 1, characterized by a folding groove or perforated folding-line, described on at least part of the pre-defined folding line of the lid body that splits on the outer-lid surface of the lid body.

3. A natto (fermented soybeans) container, according to claim 1, characterized by the bottom part of the seasoning-holding recess slanting toward the splittable groove.

4. A natto (fermented soybeans) container, according to claim 1, characterized by a separation procedure existing in the vicinity of the hinge part that lets the lid body be detached from the container body.

5. A natto container, according to claim 4, characterized by the pre-defined folding line described in parallel with the hinge part.

6. A natto container, according to claim 1, characterized by an encompassing groove described on the lid body that does not cross the pre-defined folding line yet encompasses the seasoning-holding recess and the splittable groove.

7. The natto and natto seasoning that are held respectively in the natto-holding recess and in the seasoning-holding recess of the container body, according to claim 1.

8. The method for making the natto packed in the container body, according to claim 1, characterized in comprising a natto-seasoning filling process for filling the natto seasoning into the natto-seasoning holding recess of the lid body; a sealing process, using a sealant material, for sealing the natto-seasoning holding recess filled with the natto seasoning; a steamed-soybeans filling process for filling the natto-holding recess of the container body with steamed soybeans; a lid-body closing process for closing the lid body filled with the natto seasoning and sealed by a sealant material to cover the natto-holding recess filled with the fermented soybeans; and a fermenting process for fermenting in a fermenting room Bacillus subtilis natto in the container body filled with both the steamed soybeans and the natto seasoning.

9. The method for making the natto packed in the container body, according to claim 1, characterized in comprising a steamed-soybeans-filling process for filling the natto-holding recess with steamed soybeans; a lid-closing process for closing the lid body of the natto container, thus sealing the natto-holding recess filled with the steamed soybeans;
a natto-seasoning filling process for filling the natto-seasoning holding recess of the lid body with natto seasoning; by a sealing process, using a sealant material, for sealing the natto-seasoning holding recess filled with the natto seasoning; and
a fermenting process for fermenting in a fermenting room Bacillus subtilis natto in the container body filled with both the steamed soybeans and the natto seasoning.

10. The method for making the natto packed in the container body, according to claim 1, characterized in comprising a steamed-soybeans filling process for filling the natto-holding recess of the container body with the steamed soybeans; a lid-closing process for closing the lid body of the container body, thus sealing the natto-holding recess filled with the steamed soybeans; a fermenting process for fermenting in a fermenting room Bacillus subtilis natto in the container body filled with the steamed soybeans; a seasoning-filling process for filling the seasoning-holding recess of the lid body with natto seasoning; and a sealing process, using a sealant material, for sealing the seasoning-holding recess filled with the natto seasoning.
